(19) United States
(12) Patent Application Publication
(10) Pub. No.: US 2015/0170092 A1
(43) Pub. Date: Jun. 18, 2015

(54) VERIFICATION OF RESPONSE TO INQUIRY

(71) Applicant: JEFFREY A. KLEIN, M.D., INC., San Juan Capistrano, CA (US)

(72) Inventor: Jeffrey Alan Klein, San Juan Capistrano, CA (US)

(21) Appl. No.: 14/574,307

(22) Filed: Dec. 17, 2014

Related U.S. Application Data
(60) Provisional application No. 61/917,303, filed on Dec. 17, 2013.

(51) Int. Cl. G06Q 10/06; H04L 12/58

(52) U.S. Cl. CPC G06Q 10/06398; H04L 51/34

(57) ABSTRACT

In a method for business leads monitoring, an inquiry can be sent to a service provider from a client for receiving a service from a service provider. Time and date information of the inquiry can be stored and the inquiry is forwarded to the service provider. A reply can be received from the service provider. The reply is forwarded to the client. Time and date information of the reply is stored. Based on the information of the reply and the information of the inquiry, it is determined whether the reply has been received within a predetermined period of time. When it is determined that the reply message has not been received within the predetermined period of time, a notification is sent to a service provider indicating that the reply in response to the inquiry has not been sent within the predetermined period of time.

### CROSS-REFERENCE TO RELATED APPLICATIONS

This application claims priority benefit of U.S. Provisional Patent Application No. 61/917,303, filed Dec. 17, 2013, which is incorporated herein by reference in its entirety.

### BACKGROUND

Many companies spend considerable amounts of money and resources to advertise on Internet directories and to optimize search engine results in an effort to increase business leads and sales. When a prospective customer sends an inquiry (e.g., an email, a call, etc.) to a company or a service provider, such as a private practice cosmetic surgeon's office, the staff of the company is expected to respond promptly to the inquiry. If the response to the enquiry is delayed or if a response never occurs, then the service provider may lose a valuable business opportunity.

However, many business owners are often too busy with other professional responsibilities to monitor the response rates or the promptness of the responses by staff members. As a consequence, business owners may be victimized by their own staff's laziness and incompetence.

### SUMMARY

Thus, a system and method for automatic monitoring and reporting of the staff's performance are needed. Various exemplary embodiments of the present inventive concept described herein provide methods and systems for automatically monitoring and reporting of the staff's performance relating to promptness of their responses in response to inquiries by prospective clients.

An exemplary embodiment of the inventive concept provides for a computer-implemented method for business lead monitoring as follows. An inquiry email is sent to a service provider from a device of a client for receiving a service from a service provider. Time and date information of the inquiry email is stored and the inquiry email is forwarded to the service provider. In response to the inquiry email, a reply email is received from the service provider. The reply email is forwarded to the client. Time and date information of the reply email is stored. Based on the information of the reply email and the information of the inquiry email, it is determined whether the reply email has been received within a predetermined period of time. When it is determined that the reply email has not been received within the predetermined period of time, a notification is sent to a service provider indicating that the reply email in response to the inquiry email has not been sent within the predetermined period of time.

Another exemplary embodiment of the inventive concept provides for a computer-implemented method for business lead monitoring as follows. An inquiry email is sent to a service provider from a device of a client for receiving a service from a service provider. Time and date information of the inquiry email is stored. The inquiry email is sent to the service provider. In response to the inquiry email, it is determined whether a reply email has been received within a predefined period of time. When it is determined that no reply email has been received within the predetermined period of time, a notification is sent to a service provider indicating that no reply email in response to the inquiry email has been sent within the predetermined period of time.

As a result, the staff's performance relating to promptness of their responses in response to inquiries by prospective clients can be automatically and accurately monitored. Consequently, business leads can be effectively managed and lead to potentially profitable business opportunities for the service provider.

Other concepts relate to unique software for implementing the business leads management. A software product, in accord with this concept, includes at least one machine-readable medium and information carried by the medium. The information carried by the medium may be executable program code, one or more databases and/or information regarding determining whether inquiries are answered in a timely fashion and sending a notification to the service provider.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional block diagram of an example of a system of networks/devices embodying the inventive concept.

FIGS. 2A and 2B are high-level process diagrams embodying the inventive concept.

FIG. 3 is a simplified functional block diagram of a computer that may be configured as a host or server, for example, to function as the server 111 in FIG. 1.

FIG. 4 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

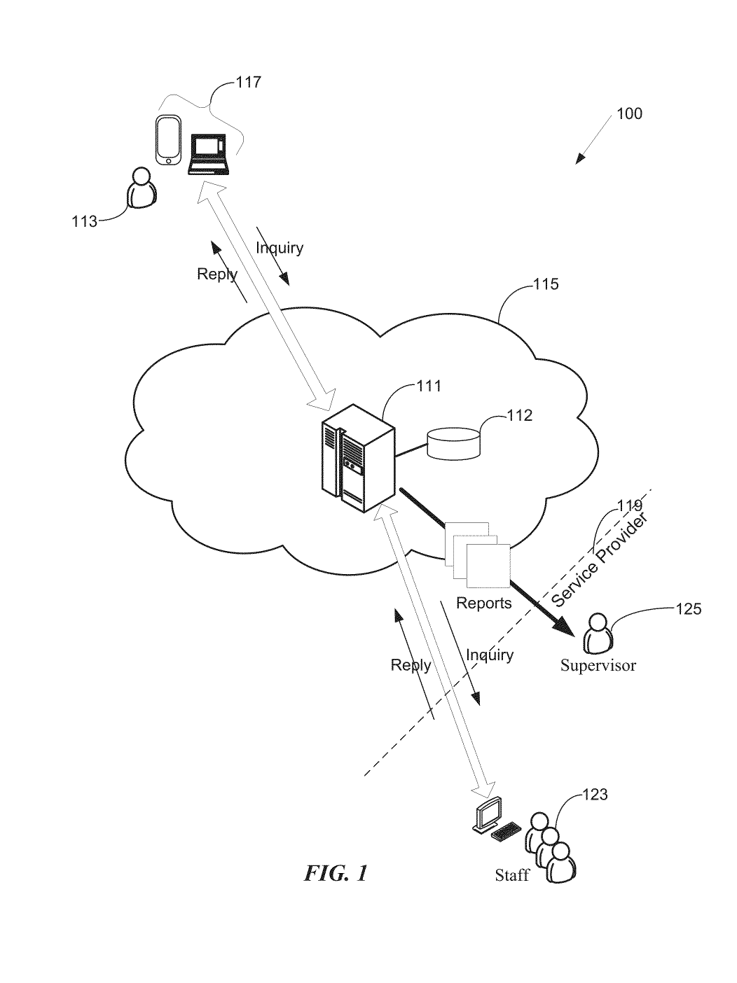

Reference now is made in detail to the examples illustrated in the accompanying drawings and discussed below. FIG. 1 illustrates a high-level functional block diagram of an example of a system of networks/devices embodying the inventive concept.

FIG. 1 illustrates a system 100 for monitoring customer leads, as disclosed herein. The system 100 includes a current or prospective client 113 (hereinafter “client”) with a device 117, a server 111, a database 112, staff 123, and a supervisor 125 of a service provider 119. As used herein, a client can be a consumer, a customer, a patient, a vendor, etc. As used herein, a client can be a prospective client, a potential client, a current client, a former client, etc. For the purpose of simplicity, the example shows simply a few elements of the system 100. The network 115 is a general network providing wireless as well as wired communications services (e.g., connection to Internet, etc.) to various devices such as mobile computing devices 117 and non-mobile computing devices. The present techniques may be implemented in any of a variety of available networks 115 and/or on any type of mobile device compatible with such the network 115.

The prospective client 113 of the device 117 (e.g., a mobile phone, a tablet, a notebook, a computer, etc.) accesses the Internet via the network 115 for receiving a service from a service provider. In the example discussed herein, the service provider is a medical service provider such as a physician and the service can be a medical procedure or operation. However, the service provider can be any other professional(s) in other fields.

For obtaining a particular service, the prospective client 113 generally does research on a topic relating to the medical procedure and search for a suitable service provider near home or preferred locations. Often, the prospective client 113 may have some specific questions regarding the medical procedure relating to the medical procedure that the prospective client 113 is planning to receive from the service provider 119. So, the prospective client 113 sends an inquiry (e.g., an inquiry email) to the service provider 119 over the network 115, which is delivered to the service provider 119 via a server 111.

The server 111 can be a web server or any other application server hosting one or more web pages for the service provider 119. The server 111 receives the inquiry from the prospective client 113 and obtains certain information such as time and date information of the inquiry from the device 117. Upon receiving the inquiry from the prospective client 113, the server 111 stores the time and date information of the inquiry and stores some identification information associated with the inquiry. Further, the identification information may include an Internet Protocol (IP) address of the device 117 and identification of the prospective client 113 (e.g., name, address, contact info, etc.). Alternatively, the server 111 can store the time and date information of the inquiry and stores some identification information associated with the inquiry in a database 112. Alternatively, the server 111 encrypts and stores the inquiry email along for later use and analysis purposes.

The server 111 examines the recipient address of the inquiry and forwards the inquiry to a designated recipient of the service provider 119. In the exemplary embodiment, the inquiry is forwarded to one of staff members 123 of the service provider 119. Upon receipt of the inquiry, the staff member 123 reviews content of the inquiry and investigates, if needed, to answer any questions the prospective client 113 has. The staff member 123 composes a reply in response to the inquiry and sends the reply back to the client 113 over the network 115. The reply is sent from the staff member 123 to the prospective client 113 via the server 111 on the network 115. Upon receiving the reply from the staff member 123, the server 111 obtains certain information such as time and date information of the reply from the staff member 123, and stores the information associated with the reply. The information can be stored in the database 112. The server 111 then forwards the reply to the prospective client 113. Based on the stored information of the inquiry and the responsive reply, the server 111 determines whether the reply has been composed and sent out to the prospective client 113 within a predetermined period of time. As used herein, an inquiry and/or a reply can be any electronic communication or message, including email, text message, voicemail, instant message, chat request, conference request, etc.

In one implementation, the prospective client views a website (e.g., liposuction.com, a real estate company's website, a company's private website, a government agency's website, etc.) and sends an email inquiry to the service provider. Also, an automatic CC of the email is sent to the website. As soon as the service provider responds to inquiry with a return email, another CC email is also sent to the website. The elapsed time of email inquiry, time between inquiry and response emails and additional information are recorded by the website. This information is sent by email or text to an executive of the service provider.

In another implementation, the prospective client views a website directory hosted by a server and sends an email inquiry to the service provider. The prospective client's email goes to the server where email is recorded and the email is forwarded to the service provider. When the service provider responds to inquiry by email, the email goes through the server which records the elapsed time of email inquiry, time between inquiry and response emails and additional information. The information is sent by email or text to an executive of the service provider.

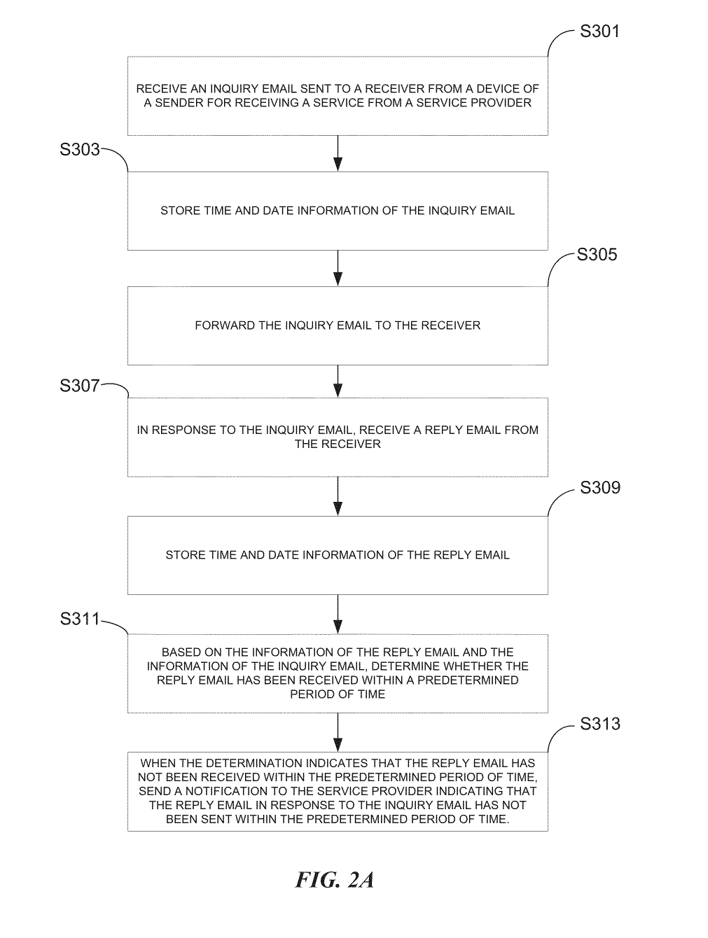

FIGS. 2A and 2B provide high-level flow diagrams for monitoring and managing inquiries (e.g., emails) from prospective clients. By way of illustration, as in FIG. 2A, first, at S301, an inquiry email is sent out by a client 113 using a device in order to obtain a service. The inquiry email is received at the server 111. At 303, certain information including time and date information (e.g., time and date stamps of the inquiry email, etc.) of the inquiry email is stored for later use. The information may include identification information such as an

Internet Protocol (IP) address of the device 117 and identification of the prospective client 113 (e.g., name, address, contact info, etc.). At S305, the inquiry email is forwarded to the service provider 119 (e.g., a staff member 123 of the service provider 119). At S307, in response to the inquiry email, a reply email is received from the service provider 119. At S309, certain information including time and date information (e.g., time and date stamps of the email, identification of a staff member who is responding to the inquiry email, etc.) of the reply email is stored. At S311, based on the time and date information of the reply email and the time and date information of the inquiry email, it is determined whether the reply email has been sent out within a predetermined period of time. For example, the predetermined period of time can be set beforehand by the service provider 119, such as 5 hours or 8 hours for a response time after receiving an inquiry, depending upon specific needs and requirements of the service provider 119. When it is determined that the reply email has not been sent out within the predetermined time period by a staff member, at S313, a notification is prepared and sent to the service provider or a supervisor 125 of the staff member 123. The service provider 119 or the supervisor 125 of the staff member 123 can review the inquiry email and response time and take appropriate action.

FIG. 2B provides another exemplary embodiment of the inventive concept. As illustrated in FIG. 2B, at S401, an inquiry email is sent out by a client 113 to obtain information relating to a service and the inquiry email is received at the server 111. At 403, certain information including time and date information (e.g., time and date stamps of the inquiry email, etc.) of the inquiry email is stored for later use (e.g., in a database). The information may include identification information such as an Internet Protocol (IP) address of the device 117 and identification of the prospective client 113 (e.g., name, address, contact info, etc.). At S405, the inquiry email is forwarded to the service provider 119 (e.g., a staff member 123 of the service provider 119). At S407, in response to the inquiry email, the server 111 determines whether a reply email has been received within a predefined period of time. For example, the predetermined period of time can be set beforehand by the service provider 119, such as 5 hours or 8 hours response time, depending upon needs and requirements of the service provider 119. When it is determined that the reply email has not been sent out within the predetermined time period by a staff member, at S409, a notification is prepared and sent to the service provider 119 or a supervisor 125 of the staff member 123 informing that the reply email has not been sent out in response to the inquiry email. The notification may include the content of the inquiry email and contact information of the client 113 (e.g., an IP address, telephone number, email address, etc.). The service provider 119 or the supervisor 125 of the staff member 123 can review the inquiry email, along with other information, and take appropriate action.

Alternatively, the notification can be sent automatically to the supervisor (or owner or manager of the service provider) or the notification can be made by a personal telephone call by an answering service or by a text message to the supervisor.

Further, the server 111 can generate a report on the performance of each of the staff member as to responding to inquiries from the prospective clients 113 on a regular basis. For example, on a weekly basis, a report of the staff's performance can be generated and sent to the supervisor 125, providing (i) the number of inquiries, (ii) the length of time between email receipt and reply, (iii) a list of all emails or inquiries that remain unanswered, and (iv) other relevant information. Based on the report and information contained therein, the supervisor 125 can review the performance of each staff member and take any responsive action, such as providing additional training, prizes, awards for prompt responses, etc. For example, if the reply was sent promptly, then the supervisor can award the staff member for providing good client service.

Furthermore, it is noted that in the disclosed technology herein, can be implemented for emails as well as other forms of communications, such as voice mails, text messages, or asynchronous communications methods.

As shown by the above discussion, functions relating to the business leads monitoring service may be implemented on computers connected for data communication via the components of a packet data network, operating as an server as shown in FIG. 1. Although special purpose devices may be used, such devices also may be implemented using one or more hardware platforms intended to represent a general class of data processing device commonly used to run “server” programming so as to implement the business lead monitoring functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the monitoring and management of inquiries from the prospective clients and replies from the service provider. The software code is executable by the general-purpose computer that functions as the business lead monitoring server and/or that functions as a terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for business leads monitoring and management, in essentially the manner performed in the implementations discussed and illustrated herein.

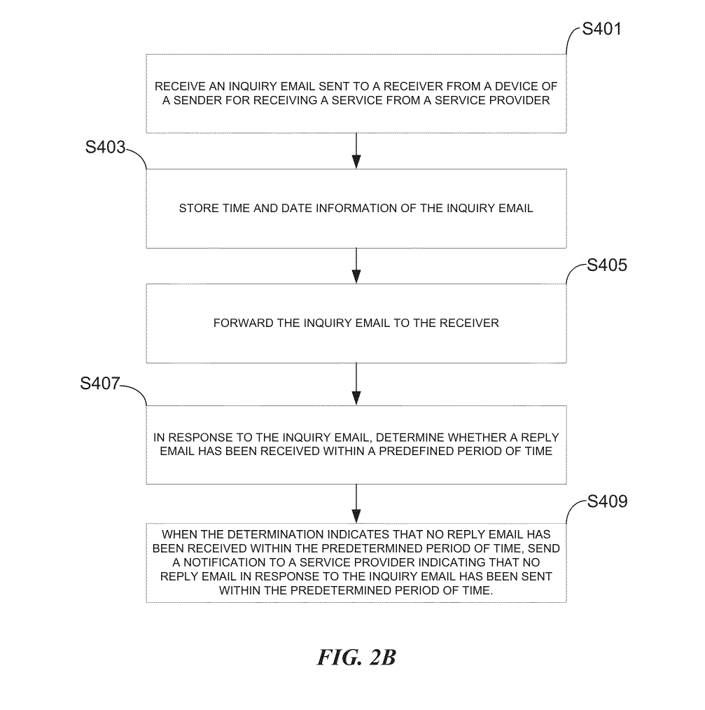

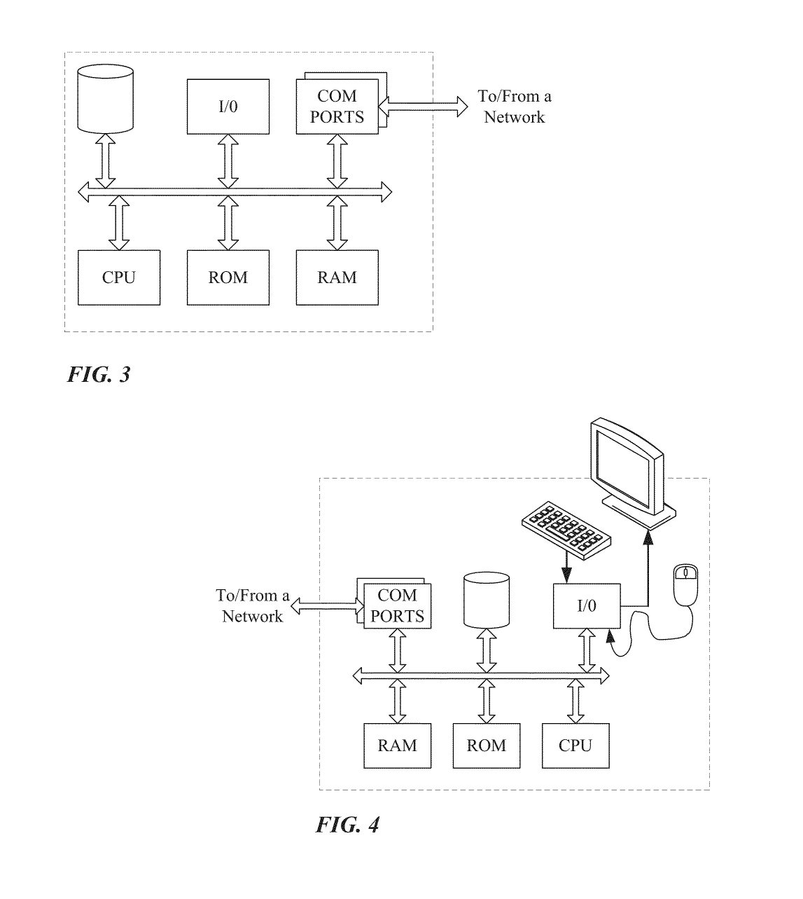

FIGS. 3 and 4 provide functional block diagram illustrations of general purpose computer hardware platforms. FIG. 3 illustrates a network or host computer platform, as may typically be used to implement a server. FIG. 4 depicts a computer with user interface elements, as may be used to implement a personal computer or other type of work station or terminal device, although the computer of FIG. 4 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of the subject technology outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into another computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the business lead monitoring functions, etc. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following paragraphs or clauses to encompass any and all applications, modifications and variations that fall within the true scope of the present teachings.

What is claimed is:

1. A computer-implemented method, for business lead monitoring via a processor, comprising:
receiving, by a processor, an electronic inquiry message sent to a service provider from a client;
storing time and date information of the inquiry message;
in response to the inquiry message, sending an electronic reply message from the service provider to the client;
storing time and date information of the reply message;
based on the information of the reply message and the information of the inquiry message, determining whether the reply message has been received within a predetermined period of time; and
when the determination indicates that the reply message has not been received within the predetermined period of time, sending a notification to a service provider indicating that the reply message in response to the inquiry message has not been sent within the predetermined period of time;
generating, by a processor, a report including information at least on (a) a number of inquiries from clients over a period of time, (b) a length of elapsed time between receipt of the inquiry message and the reply message, and (c) a list of pending inquiry messages that remain unanswered; and
displaying the report at the service provider.

2. The computer-implemented method of claim 1, wherein the service provider is a medical service provider.

3. The computer-implemented method of claim 1, wherein the processor includes one or more processors.

4. The computer-implemented method of claim 1, wherein the determining comprises:
determining an elapsed time duration between time and date information of the inquiry message and the time and date information of the reply message; and
determining whether the elapsed time duration is within the predetermined period of time.

5. The computer-implemented method of claim 1, wherein the sending of the notification to the service provider comprises sending a message to the service provider by message, text, or phone.

6. The computer-implemented method of claim 1, further comprising:
receiving an Internet Protocol (IP) address of the client and an identity of the client; and
if an inquiry message from the client is not answered within the predetermined period of time, sending a notification to the service provider including the IP address of the client and the identity of the client.

7. A computer-implemented method, for business lead monitoring via a processor, comprising:
receiving, by a processor, an inquiry message sent to a service provider from a client;
storing time and date information of the inquiry message;
in response to the inquiry message, determining whether a reply message has been received within a predefined period of time;
when the determination indicates that no reply message has been received within the predetermined period of time, sending a notification to a service provider indicating that no reply message in response to the inquiry message has been sent within the predetermined period of time;
generating, by a processor, a report including information at least on (a) a number of inquiries from clients over a period of time, (b) a length of elapsed time between receipt of the inquiry message and the reply message, and (c) a list of pending inquiry messages that remain unanswered; and
displaying the report at the service provider.

8. The computer-implemented method of claim 7, wherein the service provider is a medical service provider.

9. The computer-implemented method of claim 7, wherein the processor includes one or more processors.

10. The computer-implemented method of claim 7, wherein the sending of the notification to the service provider comprises sending a message to the service provider by message, text, or phone.

11. The computer-implemented method of claim 7, wherein the determining step comprises:
determining an elapsed time duration between time and date information of the inquiry message and time and date information of the reply message; and
determining whether the elapsed time duration is within the predetermined period of time.

12. The computer-implemented method of claim 7, further comprising:
receiving an Internet Protocol (IP) address of the client and an identity of the client; and
if an inquiry message from the client is not answered within the predetermined period of time, sending a notification to the service provider including the IP address of the client and the identity of the client.

13. A machine-readable medium comprising instructions for:
receiving, by a processor, an electronic inquiry message sent to a service provider from a client;
storing time and date information of the inquiry message;
in response to the inquiry message, sending an electronic reply message from the service provider to the client;
storing time and date information of the reply message;
based on the information of the reply message and the information of the inquiry message, determining whether the reply message has been received within a predetermined period of time; and
when the determination indicates that the reply message has not been received within the predetermined period of time, sending a notification to a service provider indicating that the reply message in response to the inquiry message has not been sent within the predetermined period of time;
generating, by a processor, a report including information at least on (a) a number of inquiries from clients over a period of time, (b) a length of elapsed time between receipt of the inquiry message and the reply message, and (c) a list of pending inquiry messages that remain unanswered; and
displaying the report at the service provider.

14. The machine-readable medium of claim 13, wherein the determining comprises:
determining an elapsed time duration between time and date information of the inquiry message and time and date information of the reply message; and
determining whether the elapsed time duration is within the predetermined period of time.

15. The machine-readable medium of claim 13, further comprising instruction for:
receiving an Internet Protocol (IP) address of the client and an identity of the client; and
if an inquiry message from the client is not answered within the predetermined period of time, sending a notification to the service provider including the IP address of the client and the identity of the client.
